(19) United States
(12) Patent Application Publication
(10) Pub. No.: US 2012/0147588 A1
(43) Pub. Date: Jun. 14, 2012

(54) OMNIDIRECTIONAL LED MODULE

(75) Inventor: Po-Cheng Yang, Taipei (TW)

(73) Assignee: CHEER SHINE LIGHTING ENTERPRISES LTD., Taipei City (TW)

(21) Appl. No.: 12/968,242

(22) Filed: Dec. 14, 2010

(51) Int. Cl. F21V 9/16; F21V 7/00

(52) U.S. Cl. 362/84; 362/235

(57) ABSTRACT

An omnidirectional LED module includes a LED package unit having a LED chip mounted in the base member thereof and a package compound molded on the base member over the LED chip for letting the light emitted by the LED chip be projected toward the outside in a diffusion angle, and a reflector that includes a light mask kept spaced from the package compound at a predetermined distance and carrying a phosphor layer that is disposed in the LED projection light path of the LED package unit and covering all the light rays emitted by the LED chip for diffusing and reflecting the light rays emitted by the LED chip and causing change of the color temperature (wavelength) of the light rays.

### BACKGROUND OF THE INVENTION

1. Field of the Invention

The present invention relates to LED technology and more particularly, to an omnidirectional LED module for LED lamp, which includes a reflector spaced above the LED package unit thereof for diffusing and reflecting all the light rays emitted by the LED package unit.

2. Description of the Related Art

Conventionally, an incandescent lamp bulb consumes much electric power during operation and is not environmentally friendly. Following fast development of LED illumination technology, environmentally friendly LED lamps are created and intensively used to substitute for conventional incandescent and fluorescent lamps. FIGS. 13˜15 illustrate designs of LED modules according to the prior art. However, these LED modules have drawbacks as follows:

1. For causing the light rays emitted by the LED chip A to change the color temperature, as shown in FIG. 13, a phosphor is used in the package compound B excitable by the light rays to change the color temperature. However, the temperature of the package compound B will rise following operation of the LED chip A. When the package compound B becomes hot, the performance of the phosphor will be lowered, affecting the quality of the color. When keeping the phosphor in a high temperature for long, the service life of the phosphor will be shortened. Further, in the design shown in FIG. 14, a phosphor is directly coated on the outer surface of the LED chip A, forming a phosphor layer D. This design reduces the consumption of the phosphor, however the problem causes by waste heat still exits.

2. As shown in FIG. 13, before going out of the package compound B, the light rays will be partially reflected by the phosphor in the package compound B toward the base member C, causing a light loss. Further, as shown in FIG. 14, the light rays emitted by the LED chip A will be reflected several times between the LED chip A and the phosphor layer D, and a part of the light rays will be reflected toward the base member C, causing a light loss.

3. The light rays emitted by the LED chip A is highly concentrated and projected onto a small area that will dazzle the eyes. When using either of the aforesaid prior art LED modules for making a LED lamp bulb for reading or illuminating purpose, the LED lamp bulb cannot use a clear bulb. To avoid dazzling the eyes, the bulb of the LED lamp bulb must be frosted, complicating the fabrication and lowering the brightness.

4. For making a LED lamp having a different wavelength, the packaging procedure must be relatively changed. Changing the packaging procedure relative increases the manufacturing cost. Further, this design does not allow the user to select the desired wavelength.

5. Because the performance of the LED chip A will be lowered when increasing the power, multiple LED chips may be connected in series or in parallel for illumination application. Thus, multiple low-power high-performance LED chips A may be connected together and modularized for making a desk lamp, street lamp or lamp panel for illumination application. However, as shown in FIG. 15, when multiple LED chips A are connected in series or in parallel to construct a lamp module, the light rays emitted by the LED chips A will be partially superimposed, causing superimposed shadows. This problem of superimposed shadows will become more serious when the radiating range is relatively reduced. Under the radiation of this light for a long period, the eyes will be injured.

### SUMMARY OF THE INVENTION

The present invention has been accomplished under the circumstances in view. It is the main object of the present invention to provide a omnidirectional LED module, which uses a reflector to diffuse and reflect the light rays emitted by the LED package unit and to cause change of the color temperature of the light rays, and therefore, a different wavelength of light can be obtained by means of changing the reflector without changing the LED package unit.

To achieve this and other objects of the present invention, an omnidirectional LED module includes a LED package unit and a reflector. The LED package unit comprises a base member, a LED chip mounted in the base member and a package compound molded on the base member over the LED chip for letting the light emitted by the LED chip be projected toward the outside in a diffusion angle. The reflector comprises a light mask kept spaced from the package compound at a predetermined distance. The light mask comprises a phosphor layer that is disposed in the LED projection light path of the LED package unit and covering all the light rays emitted by the LED chip for diffusing and reflecting the light rays emitted by the LED chip and causing change of the color temperature (wavelength) of the light.

### BRIEF DESCRIPTION OF THE DRAWINGS

FIG. 1 is an oblique elevational view of an omnidirectional LED module in accordance with a first embodiment of the present invention.

FIG. 2 is a sectional side view of the omnidirectional LED module in accordance with the first embodiment of the present invention.

FIG. 3 is a schematic sectional side view of a LED lamp bulb using the omnidirectional LED module in accordance with the first embodiment of the present invention.

FIG. 4 is a sectional side view of an omnidirectional LED module in accordance with a second embodiment of the present invention.

FIG. 5 is a sectional side view of an omnidirectional LED module in accordance with a third embodiment of the present invention.

FIG. 6 is a sectional side view of an omnidirectional LED module in accordance with a fourth embodiment of the present invention.

FIG. 7 is a sectional side view of an omnidirectional LED module in accordance with a fifth embodiment of the present invention.

FIG. 8 is a sectional side view of an omnidirectional LED module in accordance with a sixth embodiment of the present invention.

FIG. 9 is a sectional side view of an omnidirectional LED module in accordance with a seventh embodiment of the present invention.

FIG. 10 is a sectional side view of an omnidirectional LED module in accordance with an eighth embodiment of the present invention.

FIG. 11 is a sectional side view of an omnidirectional LED module in accordance with a ninth embodiment of the present invention.

FIG. 12 is a sectional side view of an omnidirectional LED module in accordance with a tenth embodiment of the present invention.

FIG. 13 is a schematic sectional view of a LED according to the prior art (I).

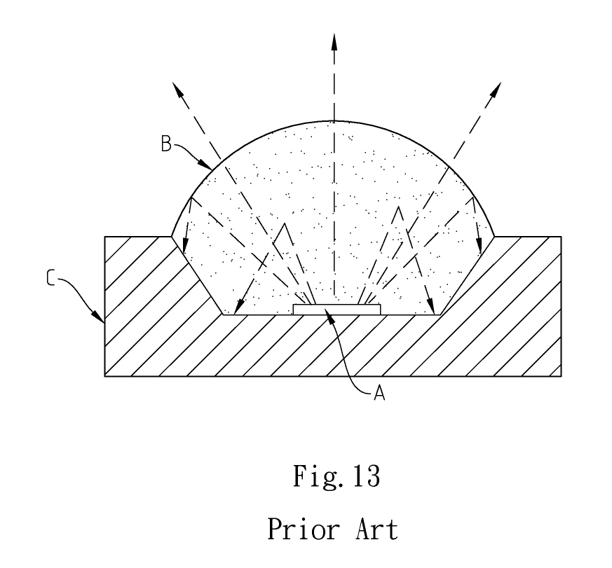

FIG. 14 is a schematic sectional view of a LED according to the prior art (II).

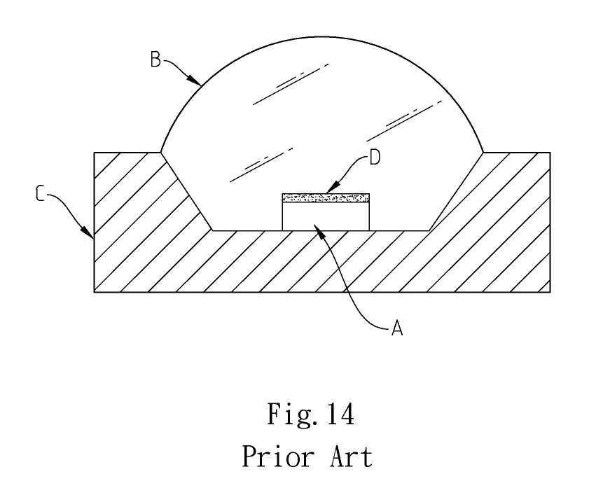

FIG. 15 is a schematic sectional view of a LED according to the prior art (III).

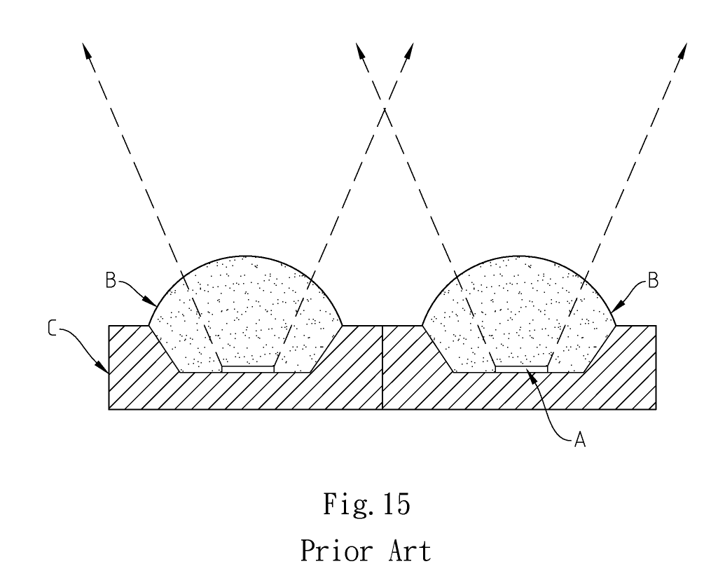

### DETAILED DESCRIPTION OF THE PREFERRED EMBODIMENT

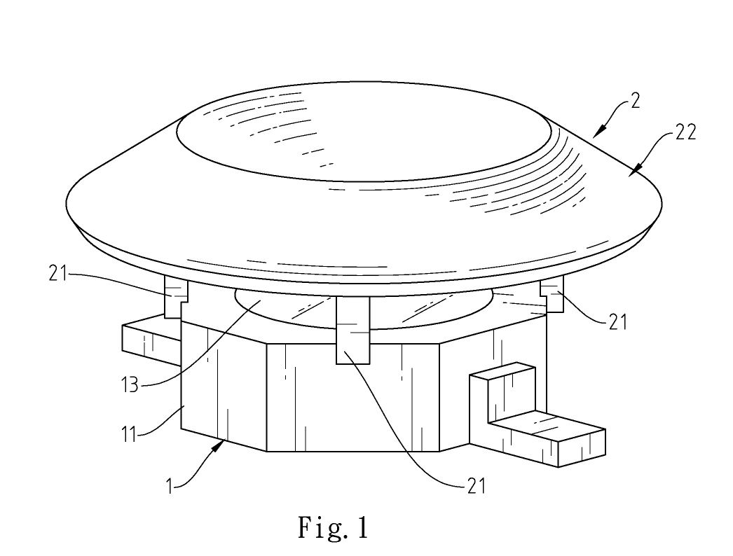

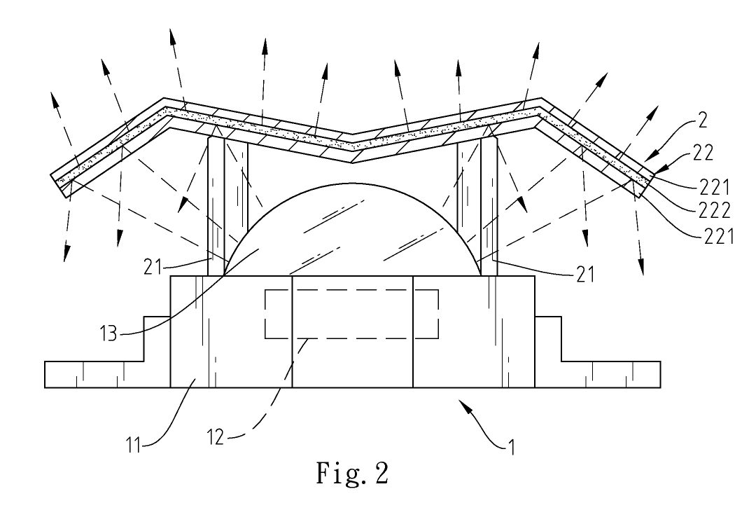

Referring to FIG. 1 and FIG. 2, an omnidirectional LED module in accordance with a first embodiment of the present invention is shown comprising a LED package unit 1 and a reflector 2.

The LED package unit 1 comprises a base member 11, a LED chip 12 mounted in the base member 11, and a package compound 13 molded on the top side of the base member 11 over the LED chip 12 for enabling the light emitted by the LED chip 12 to be projected toward the outside in a diffusion angle.

The reflector 2 comprises a plurality of upright support members 21 fastened to the top side of the base member 11 around the package compound 13, and a light mask 22 mounted on the distal ends of the upright support members 21 and spaced from the package compound 13 at a predetermined distance. The light mask 22 comprises two light transmission plates 221 made of a light transmission material, and a phosphor layer 222 made of a phosphor and sandwiched in between the two light transmission plates 221. The phosphor layer 222 is disposed in the LED projection light path of the LED package unit 1. Further, the cover range of the light transmission plates 221 and the phosphor layer 222 covers all the light rays emitted by the LED package unit 1.

As shown in FIG. 2, when the LED chip 12 is driven to emit light, the light rays directly go through the package compound 13 toward the outside. Because the phosphor layer 222 is disposed in the LED projection light path of the LED package unit 1 and the cover range of the phosphor layer 222 covers all the light rays emitted by the LED package unit 1, the light rays coming out of the package compound 13 will go through the inner light transmission plate 221 into the phosphor layer 222 to excite the phosphor in changing the color temperature of the light rays, and at the same time, the phosphor layer 222 reflects the incident light rays in all directions toward the outside.

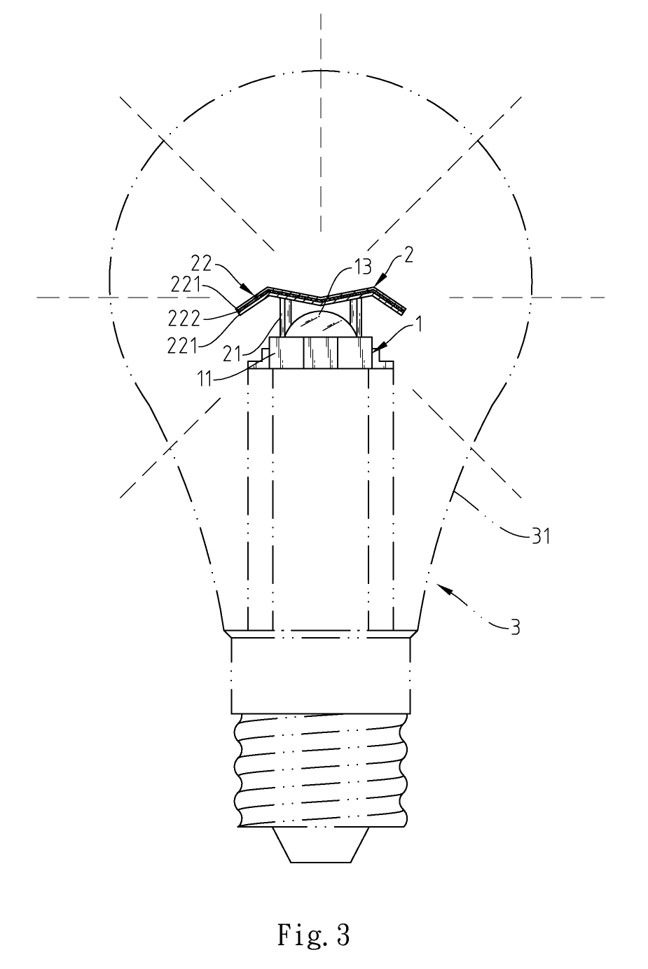

Referring to FIG. 3 and FIG. 2 again, the omnidirectional LED module can be used in a LED lamp bulb 3. During application of the LED lamp bulb 3, the LED chip 12 emits light rays through the package compound 13, and the phosphor layer 222 of the light mask 22 is excited to change of the color temperature of the light rays and reflects and diffuses the light rays in all directions, avoiding dazzling and shadows. Thus, the bulb 31 of the LED lamp bulb 3 can be directly made of a clear material for enabling the whole light intensity of the LED package unit 1 to be completely fully projected to the outside of the bulb 31. As the phosphor layer 222 of the light mask 22 causes the emitted light rays to be diffused in all directions, the LED lamp bulb 3 achieves omnidirectional illumination.

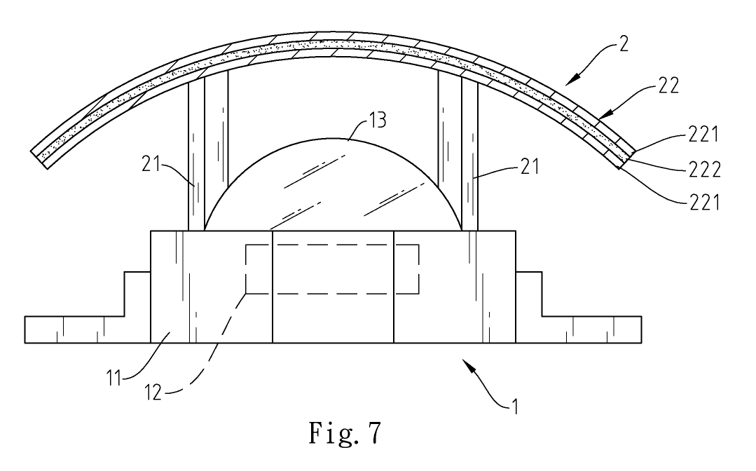

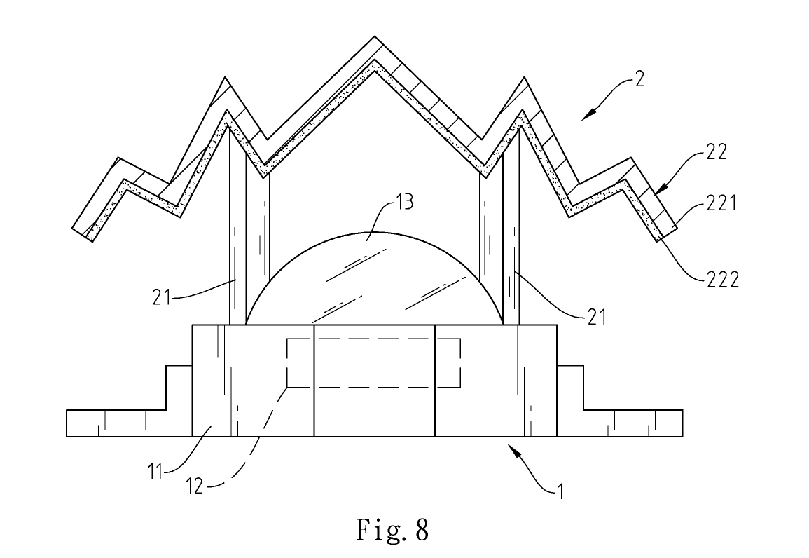

Referring to FIGS. 7 and 8 and FIG. 2 again, the phosphor layer 222 of the light mask 22 can be variously configured to fit different illumination requirements. For example, the phosphor layer 222 can be outwardly arched, inwardly arched, or continuously curved to show a wavelike configuration.

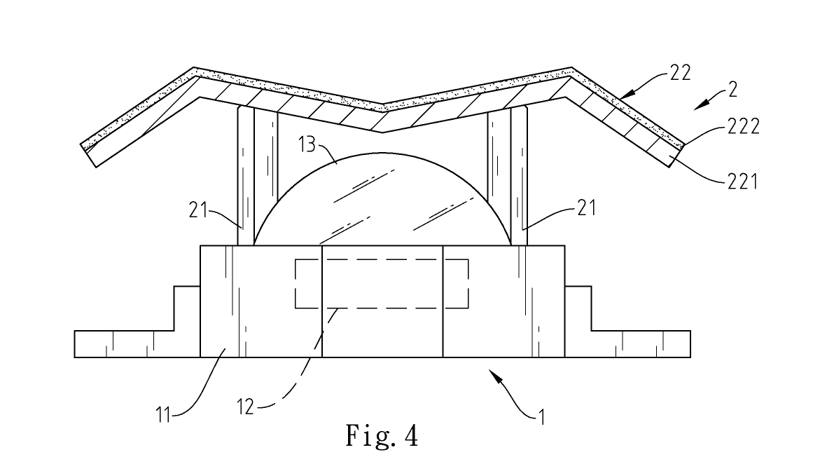

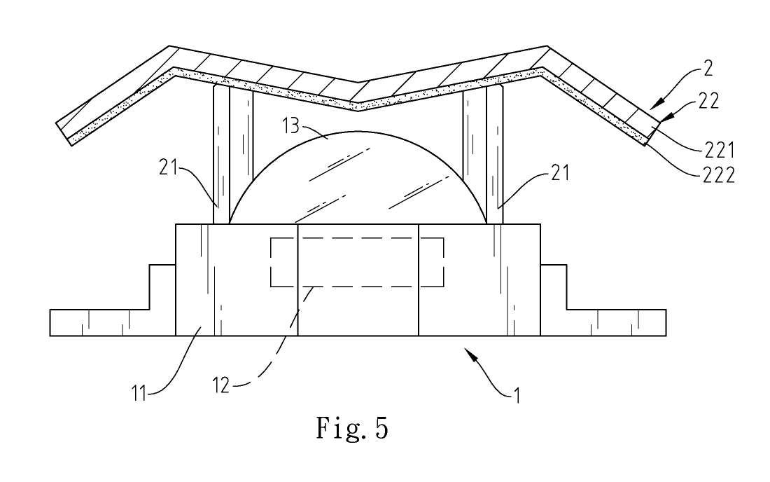

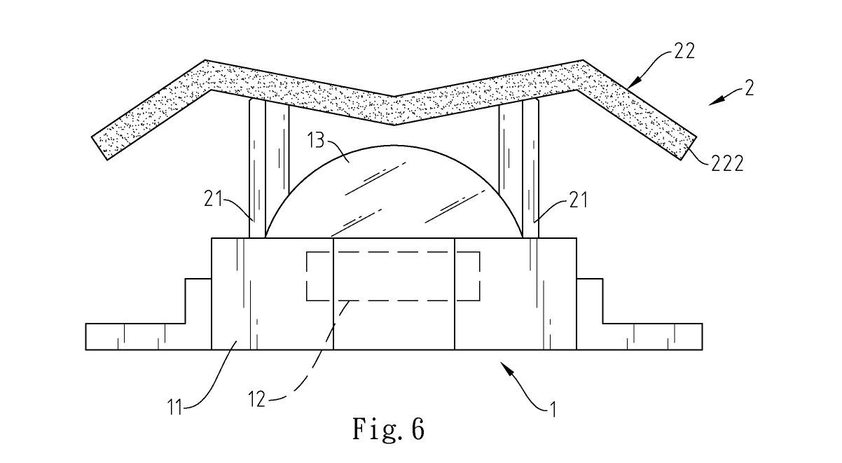

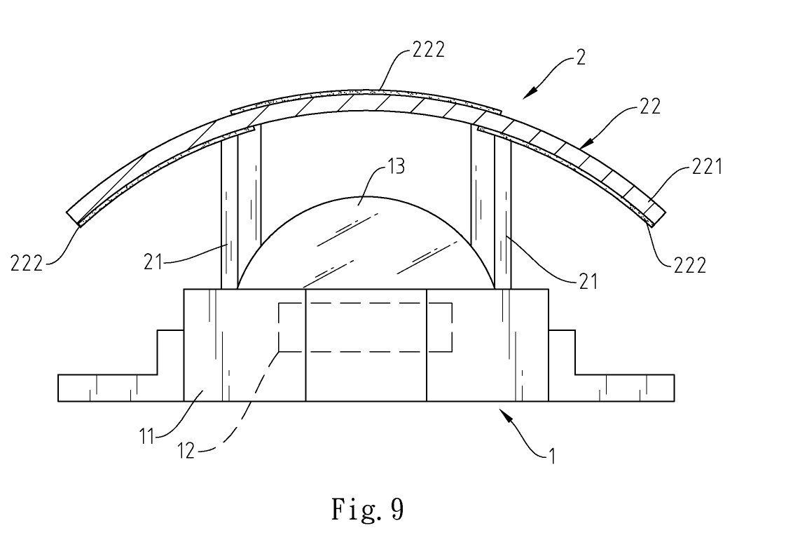

Referring to FIGS. 4, 5, 6 and 9, the light mask 22 can also be made comprising one single light transmission plate 221, and at least one phosphor layer 222 covered on the top side of the light transmission plate 221 (see FIG. 4), the bottom side of the light transmission plate 221 (see FIG. 5), or both the top and bottom sides of the light transmission plate 221 (see FIG. 9). Alternatively, as shown in FIG. 6, the light mask 22 can be made comprising a phosphor layer 222 directly made of a mixture of a phosphor and a transparent plastic compound.

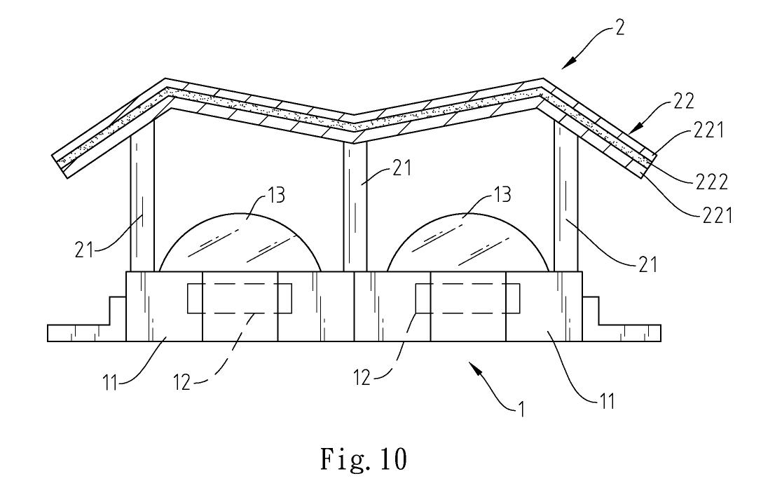

Referring to FIG. 10, the LED package unit 1 can be made comprising a plurality of base members 11, a LED chip 12 mounted in each base member 11, and a package compound 13 molded on the top side of the base members 11 over each LED chip 12 for diffusing the light emitted by each LED chip 12 toward the light mask 22 of the reflector 2, enabling the phosphor layer 222 to be excited to change the color temperature of the light rays and to diffuse the light in all directions. Because the cover range of the light mask 22 covers all the light rays emitted by the LED package unit 1, the light rays reflected by the light mask 22 forms a single light source without causing any superimposed shadows.

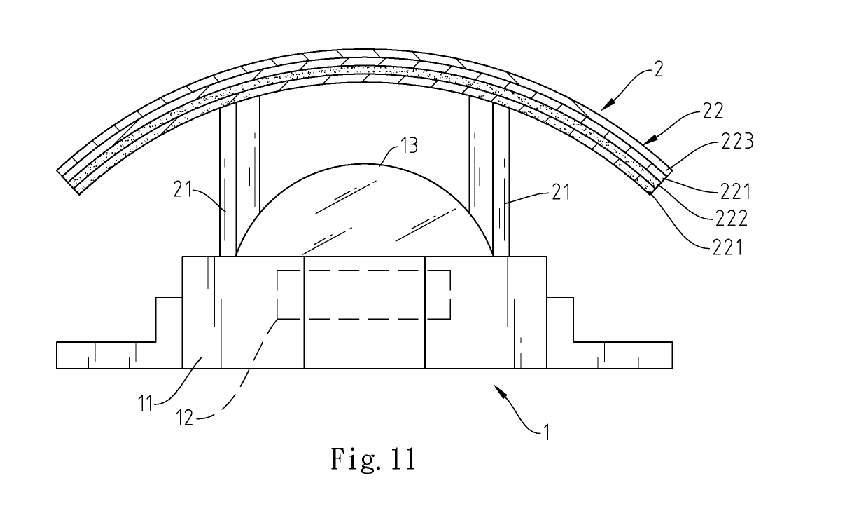

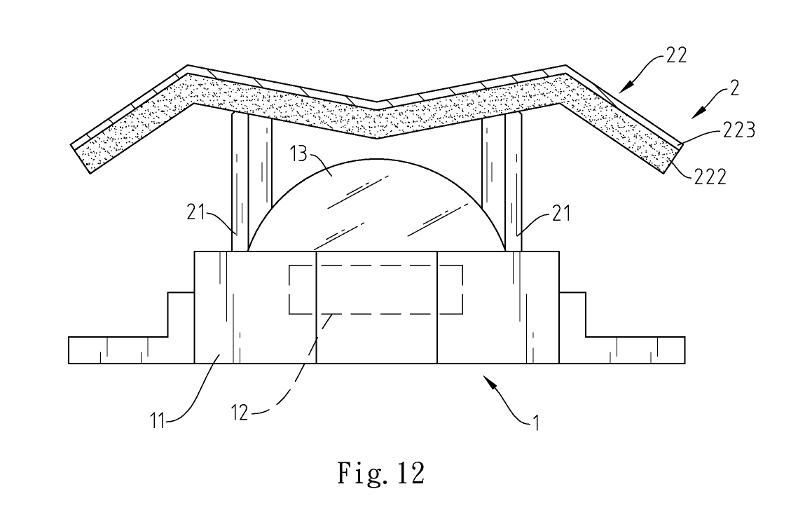

Referring to FIG. 11 and FIG. 12, the light mask 22 further comprises a reflective layer 223 covered on the outer surface of the outer light transmission plate 221 opposite to the phosphor layer 222 for reflecting the light rays been excited and diffused by the phosphor layer 222 toward a predetermined illumination area to fit a particular application requirement. Further, the light mask 22 can be made simply comprising a phosphor layer 222 directly made of a mixture of a phosphor and a transparent plastic compound and a reflective layer 223 covered on the outer surface of the phosphor layer 222.

In conclusion, the invention provides an omnidirectional LED module that has advantages and features as follows:

1. The reflector 2 is mounted on the LED package unit 1 for diffusing and reflecting the light rays emitted by the LED package unit 1 and causing change of the color temperature (wavelength) of the light rays. Different phosphors can be selectively used for making the reflector 2 to fit different application requirements without increasing the manufacturing cost of the LED package unit 1.

2. The light mask 22 is spaced from the package compound 13 at a distance, avoiding transfer of waste heat from the LED chip 12 to the phosphor layer 222 of the light mask 22 to lower the performance of the phosphor layer 222 during operation of the omnidirectional LED module, and therefore the service life of the phosphor layer 222 is effectively prolonged.

3. As the phosphor is not provided in the package compound 13, the light rays emitted by the LED chip 12 will go directly through the package compound 13 without reflection, avoiding light loss.

4. The phosphor layer 222 of the light mask 22 is disposed in the LED projection light path of the LED package unit 1 and the cover range of the phosphor layer 222 covers all the light rays emitted by the LED package unit 1, the phosphor layer 222 can effectively diffuse and reflect all the light rays emitted by the LED package unit 1 toward the outside, avoiding concentration of light, dazzling and shadows.

5. As the cover range of the light mask 22 covers all the light rays emitted by the LED package unit 1, the light rays emitted by the LED package unit 1, after having been reflected by the light mask 22, will form a single light source without causing any superimposed shadows.

Although particular embodiments of the invention have been described in detail for purposes of illustration, various modifications and enhancements may be made without departing from the spirit and scope of the invention.

What the invention claimed is:

1. An omnidirectional LED module, comprising:
a LED package unit, said LED package unit comprising at least one base member, at least one LED chip mounted in said at least one base member and a package compound molded on said at least one base member over said at least one LED chip in for letting the light emitted by said at least one LED chip be projected toward the outside in a diffusion angle; and
a reflector, said reflector comprising a light mask kept spaced from said package compound at a predetermined distance, said light mask comprising at least one phosphor layer made of a phosphor and disposed in the LED projection light path of said LED package unit and covering all the light rays emitted by said at least one LED chip for diffusing and reflecting the light rays emitted by said at least one LED chip and causing change of the color temperature (wavelength) of the light rays.

2. The omnidirectional LED module as claimed in claim 1, wherein said light mask further comprises a light transmission plate made of a light transmission material and adapted to support said at least one phosphor layer.

3. The omnidirectional LED module as claimed in claim 1, wherein said light mask further comprises a light transmission plate made of a light transmission material; said at least one phosphor layer is covered on a bottom surface of said light transmission plate.

4. The omnidirectional LED module as claimed in claim 1, wherein said light mask further comprises a light transmission plate made of a light transmission material; said at least one phosphor layer is respectively covered on opposing top and bottom surfaces of said light transmission plate.

5. The omnidirectional LED module as claimed in claim 1, wherein said light mask further comprises two light transmission plates made of a light transmission material; said at least one phosphor layer is sandwiched in between said two light transmission plates.

6. The omnidirectional LED module as claimed in claim 1, wherein said at least one phosphor layer is a single piece member directly made of a mixture of a phosphor and a transparent plastic compound.

7. The omnidirectional LED module as claimed in claim 1, wherein said reflector further comprises a plurality of upright support members fastened to said base member of said LED package unit to support said light mask on said base member at a distance from said package compound.

8. The omnidirectional LED module as claimed in claim 1, wherein said LED package unit comprises a plurality of base members, each said base member carrying one said LED chip.
